(19) United States
(12) Patent Application Publication
(10) Pub. No.: US 2025/0156383 A1
(43) Pub. Date: May 15, 2025

(54) INFORMATION PROCESSING SYSTEM, INFORMATION PROCESSING DEVICE, INFORMATION PROCESSING METHOD, AND PROGRAM

(71) Applicant: INSIGHT TECHNOLOGY, INC., Tokyo (JP)

(72) Inventor: Masaya ISHIKAWA, Tokyo (JP)

(21) Appl. No.: 18/833,678

(22) PCT Filed: Jan. 26, 2023
(86) PCT No.: PCT/JP2023/002348

§ 371 Date: Jul. 26, 2024

(30) Foreign Application Priority Data
Jan. 28, 2022 (JP) 2022-012033

(51) Int. Cl. G06F 16/21

(52) U.S. Cl. CPC G06F 16/214

(57) ABSTRACT

The present invention checks whether or not SQL works properly in a migration destination environment in a database migration test. The present invention is provided with: an SQL-statement acquisition processing unit that acquires an SQL statement; a first SQL-statement issuance processing unit that issues the acquired SQL statement to a current-environment test database; a second SQL-statement issuance processing unit that similarly issues the acquired SQL statement to a migration destination-environment test database; an SQL-statement forwarding control unit that controls the issuance of the SQL statement; a first response acquisition processing unit that acquires a first response from the current-environment test database; a second response acquisition processing unit that acquires a second response from the migration-destination-environment test database; and a response comparison processing unit that checks whether or not a normal first response and a normal second response have been acquired and that compares the first response and the second response to check whether or not the first response and the second response are the same and whether or not the execution speed of the second response is slower than that of the first response.

### TECHNICAL FIELD

The present invention relates to an information processing system, an information processing device, an information processing method, and a program.

### BACKGROUND ART

In recent years, with increases in amounts of data to be handled and increases in required processing speeds, it has become increasingly necessary to migrate a currently used database system to another database system. In the migration of a database system, for example, there is a technology in which a database migration processing terminal receives a database migration operation by using a GUI, converts the migration operation for which the instruction is given by using the GUI into an SQL statement or selects a stored procedure, and outputs a result to a display device or the like, so that a database file can be migrated visually easily and conversationally (for example, PTL 1).

### CITATION LIST

### Patent Literature

PTL 1: JP 2002-351710 A

### SUMMARY OF INVENTION

### Technical Problem

An SQL that can be used for a database system varies depending on database systems. An object of the technique disclosed in PTL 1 described above is to facilitate the migration of a data file between database systems by linking a GUI technique and an SQL statement automatic conversion process so that the migration of the database system can be performed safely and quickly even by a non-expert.

However, in the migration of a database system, there are many cases where it is difficult to cope with only the SQL statement automatic conversion. For example, there is a case where a response in a currently used database system is different from a response in a newly migrated database system due to an SQL, and there is a case where a response speed is low even if the response content matches. Therefore, there are cases where each SQL is required to be corrected according to an environment of a migration destination database. In addition, a database migration test is also required to be executed at a high speed.

Therefore, an object of the present invention is to solve the above problems, that is, to provide an information processing system, an information processing device, an information processing method, and a program capable of checking whether an SQL currently used in a database migration test correctly operates in an environment of a migration destination database system.

### Solution to Problem

According to an aspect of the present invention, an information processing system including a first database in the same environment as a current database, a second database in the same environment as a migration destination database, and an information processing device, in which the information processing device includes first SQL issuance processing means for issuing a test SQL to the first database together with a command for measuring an execution time of the test SQL; second SQL issuance processing means for issuing the test SQL to the second database together with a command for measuring an execution time of the test SQL; SQL sending control means for controlling issuance of the SQL from the first SQL issuance processing means and the second SQL issuance processing means; first response acquisition processing means for acquiring a first response from the first database; second response acquisition processing means for acquiring a second response from the second database; normal response presence/absence determination means for determining whether the first response acquisition processing means and the second response acquisition processing means have acquired the normal first response and the normal second response; response result comparison means for comparing the first response and the second response to determine whether the first response and the second response are the same in a case where the normal response presence/absence determination means determines that the normal first response and the normal second response have been acquired; and response time comparison means for comparing respective execution times in a case where the response result comparison means determines that the first response and the second response are the same.

### Advantageous Effects of Invention

According to the present invention, in a database migration test, it is possible to check whether an SQL also operates correctly in an environment of a migration destination database system.

### BRIEF DESCRIPTION OF DRAWINGS

FIG. 1 is a diagram for describing a database migration test system 1.

FIG. 2 is a functional block diagram illustrating a functional configuration of a database migration test device 11.

FIG. 3 is a diagram for describing a session.

FIG. 4 is a functional block diagram illustrating a functional configuration of a response comparison processing unit 27.

FIG. 5 is a diagram for describing a test result display process.

FIG. 6 is a diagram for describing a test result display process.

FIG. 7 is a flowchart for describing a database migration test 1.

FIG. 8 is a flowchart for describing a response result comparison process.

FIG. 9 is a flowchart for describing a database migration test 2.

### DESCRIPTION OF EMBODIMENTS

Hereinafter, an information processing system, an information processing device, an information processing method, and a program according to an embodiment of the present invention will be described with reference to the drawings.

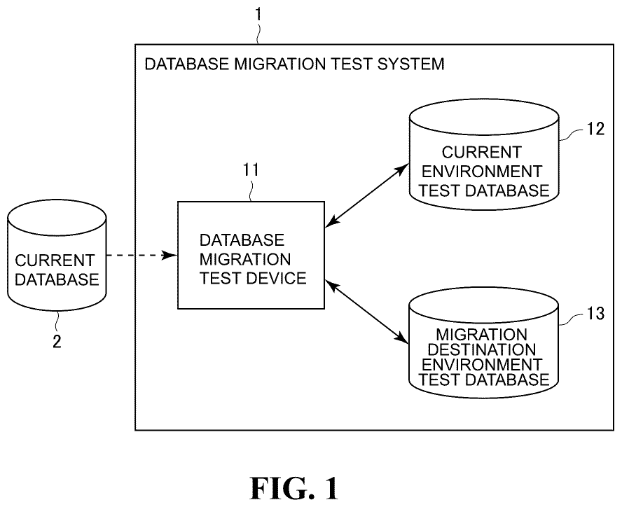

A database migration test system 1 according to an embodiment of the present invention will be described with reference to FIG. 1.

The database migration test system 1 includes a database migration test device 11, a current environment test database 12, and a migration destination environment test database 13.

The database migration test device 11 acquires an SQL necessary for a database migration test, issues the same SQL to the current environment test database 12 and the migration destination environment test database 13, and notifies a user of response results. The database migration test involves checking whether an SQL used in the current database operates correctly in a migration destination database. Therefore, an SQL used for the test is desirably an SQL executed on the current database.

The current environment test database 12 is a test database in the same environment as the current database. The migration destination environment test database 13 is a test database in the same environment as the migration destination database.

The database migration test system 1 can cope with a database of any method such as a current database and a migration destination database. In comparing results in different database types, it is preferable that the data stored in the current environment test database 12 and the migration destination environment test database 13 be basically converted into text, and each response can be executed through comparison between pieces of text.

Modes of the database migration test include parsing (syntax analysis) and execution. In a case where the execution mode is selected, a roll back mode and a commit mode are SQL execution result storage modes. In the rollback mode, processing is canceled during a transaction and a database is returned to a state before execution of the transaction. In the commit mode, a transaction is ended and a processing result is reflected in a database.

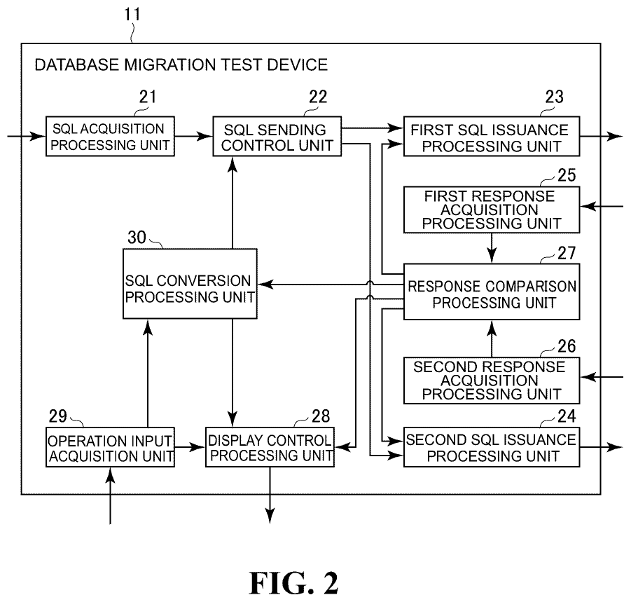

FIG. 2 is a functional block diagram for describing functions of the database migration test device 11.

The database migration test device 11 has functions including an SQL acquisition processing unit 21, an SQL sending control unit 22, a first SQL issuance processing unit 23, a second SQL issuance processing unit 24, a first response acquisition processing unit 25, a second response acquisition processing unit 26, a response comparison processing unit 27, a display control processing unit 28, an operation input acquisition unit 29, and an SQL conversion processing unit 30.

The SQL acquisition processing unit 21 acquires an SQL that is a source of a test SQL to be sent to the current environment test database 12 and the migration destination environment test database 13, and supplies the SQL to the SQL sending control unit 22. The SQL that is a source of a test SQL may be any type of SQL such as an SQL presented by a user, and the number of SQLs may be any number as long as the performance of the test is sufficiently satisfied. The SQL acquisition processing unit 21 preferably acquires an SQL actually executed on the current database. The actually executed SQL may be acquired by using any method. For example, the SQL may be acquired by investigating various audit tools executed on the current database, logs acquired by an audit function provided in the current database, source codes, or the like.

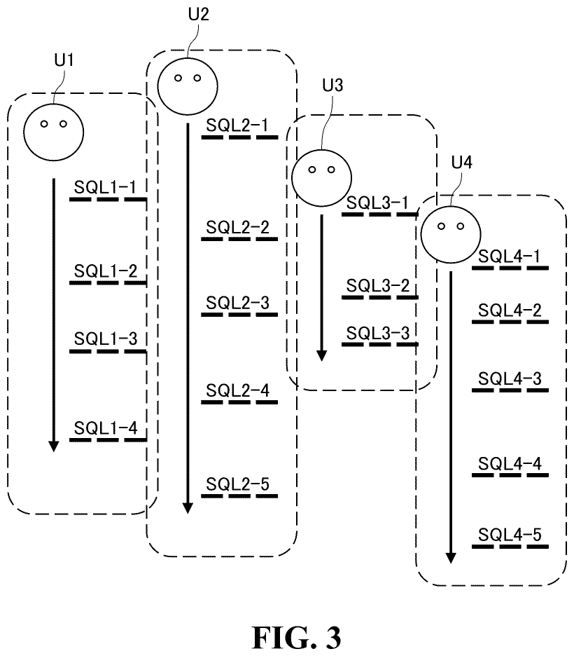

In addition, the SQL acquisition processing unit 21 acquires session information of the SQL, and supplies the session information to the SQL sending control unit 22. The session is a unit of management from when one user connects to a database until they disconnect. For example, as illustrated in FIG. 3, a plurality of users (here, a user U1 to a user U4) can access a database and sequentially perform processing. A plurality of SQLs are executed in each session. In a case where an SQL that is a source of a test SQL is an SQL actually executed on the current database, session information is acquired according to a method similar to the actually executed SQL. In a case where an SQL that is a source of test SQL is an SQL presented by a user or the like, it is also preferable to acquire session information from the user.

In addition, the SQL acquisition processing unit 21 acquires bind variable information (a data type or a value) for an SQL that uses the bind variable. The SQL acquisition processing unit 21 preferably acquires a session start time or an SQL start time. The SQL acquisition processing unit 21 accumulates the acquired SQL and accompanying information such as session information and a bind variable, and supplies the acquired SQL and accompanying information to the SQL sending control unit 22 at the time of execution of the database migration test.

The SQL sending control unit 22 controls issuance of test SQLs from the first SQL issuance processing unit 23 and the second SQL issuance processing unit 24. Specifically, the SQL sending control unit 22 assigns different identifiers to an SQL supplied from the SQL acquisition processing unit 21 for each session, sets a default value in a case where the bind variable information cannot be acquired, generates a test SQL, supplies the test SQL to the first SQL issuance processing unit 23 and the second SQL issuance processing unit 24, and controls the issuance thereof. In addition, the SQL sending control unit 22 controls issuance, from the second SQL issuance processing unit 24, of a session including a test SQL after conversion supplied from the SQL conversion processing unit 30 that will be described later, and controls issuance, from the first SQL issuance processing unit 23, of a session including a test SQL before conversion corresponding to the test SQL after conversion issued by the second SQL issuance processing unit 24.

By checking execution of an SQL in session units by using session information of the SQL, it is possible to check an operation as a cluster of a series of SQLs. Specifically, for example, it is possible to check an information acquisition result obtained by receiving a previous execution result, such as extracting necessary information after updating predetermined data. In a case where it is not necessary to consider the execution order of each session, a plurality of sessions may be tested in parallel for each of the current environment test database 12 and the migration destination environment test database 13. In addition, in the case of the roll back mode, the SQL sending control unit 22 controls issuance of test SQLs from the first SQL issuance processing unit 23 and the second SQL issuance processing unit 24 so that roll back is performed at the end of the session.

The SQL sending control unit 22 preferably performs control such that the first SQL issuance processing unit 23 and the second SQL issuance processing unit 24 issue test SQLs simultaneously or substantially simultaneously. In other words, the SQL sending control unit 22 preferably performs control such that responses from the current environment test database 12 and the migration destination environment test database 13 are substantially simultaneous.

The first SQL issuance processing unit 23 issues a test SQL together with a command for measuring an SQL execution time to the current environment test database 12 under the control of the SQL sending control unit 22. In addition, the first SQL issuance processing unit 23 preferably similarly sends a command for measuring a session execution time. In addition, upon receiving an instruction from the response comparison processing unit 27, the first SQL issuance processing unit 23 issues a command for acquiring a predetermined SQL execution plan to the current environment test database 12.

Under the control of the SQL sending control unit 22, the second SQL issuance processing unit 24 issues a test SQL (including a case of a test SQL converted by the SQL conversion processing unit 30 that will be described later) to the migration destination environment test database 13 together with the command for measuring an SQL execution time. In addition, the second SQL issuance processing unit 24 preferably similarly sends a command for measuring a session execution time. In addition, upon receiving an instruction from the response comparison processing unit 27, the second SQL issuance processing unit 24 issues a command for acquiring a predetermined SQL execution plan to the current environment test database 12.

The first response acquisition processing unit 25 acquires a response from the current environment test database 12 and supplies the response to the response comparison processing unit 27.

The second response acquisition processing unit 26 acquires a response from the migration destination environment test database 13 and supplies the response to the response comparison processing unit 27.

The response comparison processing unit 27 compares the response from the current environment test database 12 supplied from the first response acquisition processing unit 25 with the response from the test database supplied from the second response acquisition processing unit 26, and supplies a comparison result to the display control processing unit 28 and the SQL conversion processing unit 30. In addition, even if the SQL execution results in the current environment test database 12 and the migration destination environment test database 13 are the same, the response comparison processing unit 27 instructs the first SQL issuance processing unit 23 and the second SQL issuance processing unit 24 to send a command for acquiring an execution plan of a corresponding SQL in a case where it is detected that an SQL execution speed in the migration destination environment test database 13 is lower than an SQL execution speed in the current environment test database 12 through a process that will be described later.

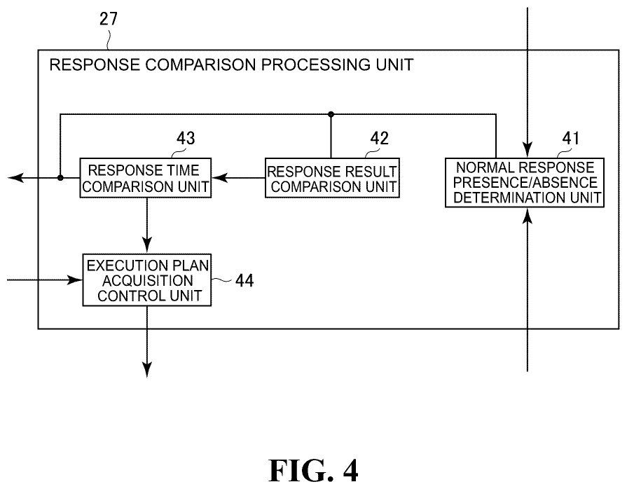

FIG. 4 is a functional block diagram illustrating more detailed functions of the response comparison processing unit 27.

The response comparison processing unit 27 has functions of a normal response presence/absence determination unit 41, a response result comparison unit 42, a response time comparison unit 43, and an execution plan acquisition control unit 44.

The normal response presence/absence determination unit 41 determines whether a normal response to the test SQL has been acquired from the current environment test database 12 and the migration destination environment test database 13 by executing the test SQL in the current environment test database 12 and the migration destination environment test database 13 on the basis of information supplied from the first response acquisition processing unit 25 and the second response acquisition processing unit 26. In a case where normal responses are acquired from both the current environment test database 12 and the migration destination environment test database 13, the normal response presence/absence determination unit 41 supplies these responses to the response result comparison unit 42. In addition, in a case where a normal response has not been acquired from at least one of the current environment test database 12 and the migration destination environment test database 13, that is, in a case where the test SQL has not been executed in at least one thereof, the normal response presence/absence determination unit 41 supplies the information to the display control processing unit 28 and notifies the SQL conversion processing unit 30 of the content of the corresponding SQL.

The response result comparison unit 42 compares the response results of the current environment test database 12 and the migration destination environment test database 13 supplied from the normal response presence/absence determination unit 41, and determines whether or not the response results are the same. In this case, there is a difference such as a difference in supported data type and accuracy depending on the type of database. Therefore, in a case where the current database and the migration destination database are different types of databases, it is necessary to align output formats, and to consider a difference in header, a difference in error handling during floating point comparison, and the like at the time of comparison.

In a case where the response results of the current environment test database 12 and the migration destination environment test database 13 are not the same, the response result comparison unit 42 supplies information indicating that the response results are not the same to the display control processing unit 28 and notifies the SQL conversion processing unit 30 of the content of the corresponding SQL. In a case where the response results of the current environment test database 12 and the migration destination environment test database 13 are the same, the response result comparison unit 42 supplies information indicating that the response results are the same to the response time comparison unit 43 together with a response result of the execution time.

The response time comparison unit 43 compares the execution times of the SQLs with the same response result supplied from the response result comparison unit 42. In a case where it is detected that the execution speed of the SQL in the migration destination environment test database 13 is the same as or higher than the execution speed of the SQL in the current environment test database 12, the response time comparison unit 43 supplies information indicating the result to the display control processing unit 28. In addition, in a case where the execution speed of the SQL in the migration destination environment test database 13 is lower than the execution speed of the SQL in the current environment test database 12, in other words, in a case where it is detected that the SQL execution performance has deteriorated, the response time comparison unit 43 notifies the execution plan acquisition control unit 44 of the result and notifies the SQL conversion processing unit 30 of the content of the corresponding SQL. Note that, in a case where the execution time of the session can be acquired, the response time comparison unit 43 compares the execution times of the respective sessions and notifies the execution plan acquisition control unit 44 of the result.

Upon receiving a notification from the response time comparison unit 43 that the execution speed of the SQL in the migration destination environment test database 13 is lower than the execution speed of the SQL in the current environment test database 12, the execution plan acquisition control unit 44 instructs the first SQL issuance processing unit 23 and the second SQL issuance processing unit 24 to send a command for acquiring an execution plan of the corresponding SQL. In addition, the execution plan acquisition control unit 44 receives supply of the execution plan from the first response acquisition processing unit 25 and the second response acquisition processing unit 26, and supplies the execution plan to the display control processing unit 28.

The execution plan of the SQL indicates a procedure in which the SQL is executed, and is created by an optimizer of each database. That is, if the optimizer statistics are not the latest, an appropriate execution plan is not created, and if an SQL is executed with an inappropriate execution plan, processing performance that would normally be realized cannot be obtained. That is, in a case where the execution speed of the SQL is reduced, it is necessary to analyze the execution plan and understand how to access a table in order to improve the performance. Therefore, the execution plan acquisition control unit 44 acquires an SQL with a reduced execution speed and supplies the acquired SQL to the display control processing unit 28.

Through these processes, the response comparison processing unit 27 compares the response from the current environment test database 12 supplied from the first response acquisition processing unit 25 with the response from the test database supplied from the second response acquisition processing unit 26, and supplies a comparison result to the display control processing unit 28 and the SQL conversion processing unit 30. As described above, the SQL sending control unit 22 preferably performs control such that issuance of test SQLs from the first SQL issuance processing unit 23 and the second SQL issuance processing unit 24 is simultaneously or substantially simultaneously performed. In other words, the SQL sending control unit 22 preferably performs control such that responses from the current environment test database 12 and the migration destination environment test database 13 are substantially simultaneous. That is, since the response comparison processing unit 27 can acquire the response from the current environment test database 12 supplied from the first response acquisition processing unit 25 and the response from the migration destination environment test database 13 supplied from the second response acquisition processing unit 26 without much time difference, it is possible to perform the comparison process at a high speed. In addition, in particular, details of a response result or a comparison result regarding an SQL that has operated without a problem are not used for subsequent processing, and thus unnecessary data can be sequentially erased depending on the capacity of a recording unit (not illustrated) included in the database migration test device 11.

Returning to FIG. 2, the display control processing unit 28 generates predetermined display image data by using the information supplied from the response comparison processing unit 27 and the operation input acquisition unit 29, and controls display on a display device (not illustrated).

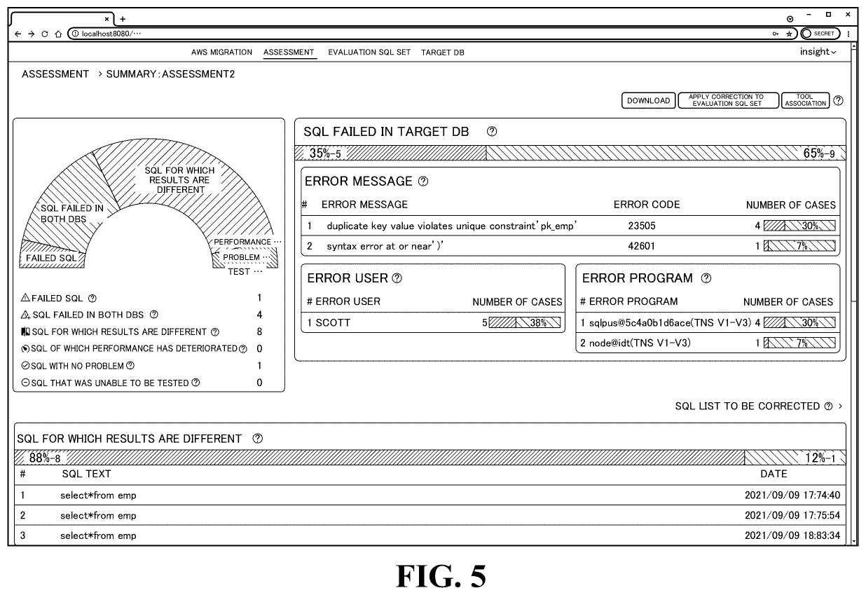

The display control processing unit 28 can control display of a summary of the database migration test, for example, as illustrated in FIG. 5. As the content of the summary, for example, among SQLs for which the test has been executed, the number of SQLs for which a response has not been acquired from at least one of the current environment test database 12 and the migration destination environment test database 13, the number of SQLs for which response results of the current environment test database 12 and the migration destination environment test database 13 are not the same, the number of SQLs for which an execution speed of an SQL in the migration destination environment test database 13 is lower than an execution speed of an SQL in the current environment test database 12, that is, performance has deteriorated, the number of SQLs with no problem, and the number of SQLs that has not been tested can be indicated or graphed. In addition, for example, the number of SQLs of which execution has failed, the content of an error message, an error user, an error program, each percentage, and the like in the migration destination environment test database 13 (in FIG. 5, described as a target DB) may be displayed as the content of the summary. In addition, as the content of the summary, for example, the number and a percentage of SQL statements whose execution results differed between the current environment test database 12 and the migration destination environment test database 13. A user can obtain detailed information necessary for an operation for correction by performing a desired operation on a display screen. Specifically, a user who has referred to this display screen can display a list of SQLs to be corrected, for example, by performing an operation of clicking the description of “List of SQLs to be corrected”.

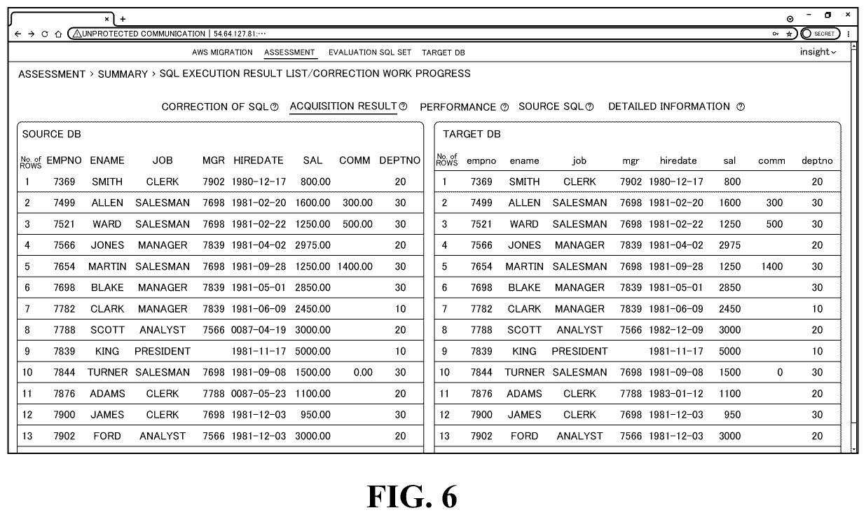

In addition, for example, the display control processing unit 28 can control display of an SQL execution result list and correction work progress information as illustrated in FIG. 6 as a list of detailed information necessary for the operation for correction. In FIG. 6, a list of execution results of each SQL in the current environment test database 12 (in FIG. 6, described as a source DB) and the migration destination environment test database 13 (in FIG. 6, described as a target DB), and display of the work progress of an SQL that needs to be corrected are controlled. A user can perform processes of converting and correcting an SQL by referring to detailed display as illustrated in FIG. 6, for example, performing an operation input for displaying an execution plan as necessary, displaying a corresponding SQL execution plan acquired by the execution plan acquisition control unit 44 of the response comparison processing unit 27, and the like.

The operation input acquisition unit 29 receives an operation input from the user who has referred to the result of the database migration test as described with reference to FIG. 5 or FIG. 6, for example, and supplies the operation input to the display control processing unit 28 or the SQL conversion processing unit 30. In addition, in a case where various operations including an SQL conversion process are performed in different devices, the operation input acquisition unit 29 functions as an input/output control unit for inputting/outputting information.

The SQL conversion processing unit 30 receives, from the response comparison processing unit 27, supply of information regarding an SQL for which it is determined that there is a problem, that is, an SQL for which a response has not been obtained from at least one of the current environment test database 12 and the migration destination environment test database 13, an SQL for which response results of the current environment test database 12 and the migration destination environment test database 13 are not the same, and an SQL for which an execution speed of the SQL in the migration destination environment test database 13 is lower than an execution speed of the SQL in the current environment test database 12. The conversion processing unit 30 acquires the operation input of the user that has referred to various kinds of information of which display is controlled from the display control processing unit 28, for example, the information described with reference to FIG. 5 or FIG. 6 or the execution plan operation of the SQL, from the operation input acquisition unit 29, executes a conversion process for testing again the SQL executed in the migration destination environment test database 13, and supplies a conversion result to the SQL sending control unit 22. The conversion processing unit 30 receives the operation input of the user that has referred to various kinds of information of which display is controlled by the display control processing unit 28, for example, the information described with reference to FIG. 5 or FIG. 6 or the execution plan operation of the SQL, from the operation input acquisition unit 29, executes a conversion process for testing again the SQL executed in the migration destination environment test database 13, and supplies a conversion result to the SQL sending control unit 22.

As described above, the SQL sending control unit 22 controls issuance, from the second SQL issuance processing unit 24, of a session including a test SQL after conversion, and controls issuance, from the first SQL issuance processing unit 23, of a session including a test SQL before conversion corresponding to the test SQL after conversion issued by the second SQL issuance processing unit 24.

Note that, although it has been described here that the database migration test device 11 has the function of the SQL conversion processing unit 30, a device different from the database migration test device 11 may have the function of the SQL conversion processing unit 30. Specifically, an SQL determined to have a problem from the response comparison processing unit 27 may be supplied to a device having a function similar to that of the SQL conversion processing unit 30, different from the database migration test device 11, via a data input/output unit (not illustrated), and the SQL sending control unit 22 may acquire the SQL to which the conversion process for performing a test again has been applied, via a data input/output unit (not illustrated).

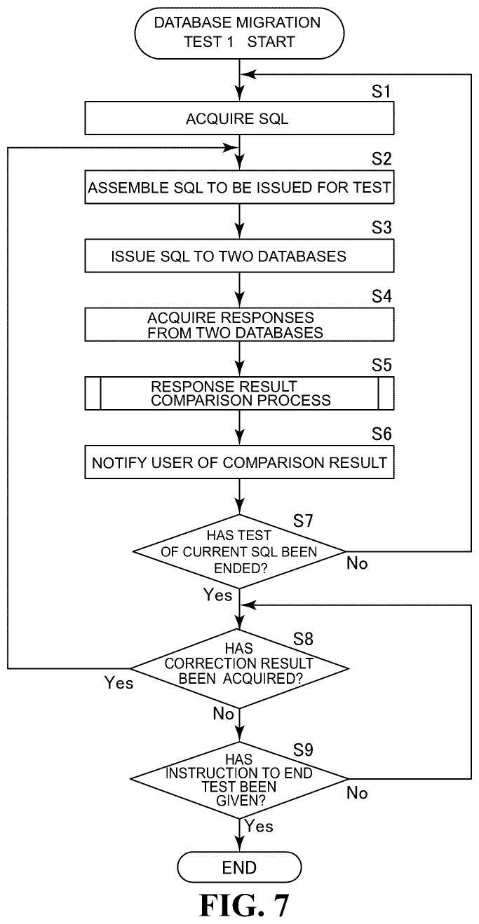

Next, a database migration test 1, which is an example of a database migration test executed by the database migration test device 11, will be described with reference to a flowchart of FIG. 7.

In step S1, the SQL acquisition processing unit 21 acquires an SQL that is a base of a test SQL such as an SQL actually executed on the current database together with session information and a bind variable, and supplies the SQL, the session information, and the bind variable to the SQL sending control unit 22.

In step S2, the SQL sending control unit 22 assembles an SQL to be issued for a test from the SQLs supplied from the SQL acquisition processing unit 21 and accumulated. Specifically, the SQL sending control unit 22 assigns different identifiers to the supplied SQLs for each session, sets a default value in a case where bind variable information cannot be acquired, and generates a test SQL. Note that, although it is described here that the processing proceeds to step S2 after the process in step S1 is ended, instead of the SQL acquisition processing unit 21 acquiring one SQL that is a base of the test SQL and proceeding to step S2, the SQL acquisition processing unit 21 continues to acquire an SQL even while other processing is being executed, and the SQL is accumulated as appropriate and then supplied to the SQL sending control unit 22.

In step S3, the SQL sending control unit 22 supplies the test SQL to the first SQL issuance processing unit 23 and the second SQL issuance processing unit 24, and controls the issuance of the test SQL. The SQL sending control unit 22 performs control such that the first SQL issuance processing unit 23 and the second SQL issuance processing unit 24 issue the test SQL simultaneously or substantially simultaneously. The first SQL issuance processing unit 23 issues a test SQL together with a command for measuring an SQL execution time to the current environment test database 12 under the control of the SQL sending control unit 22. The second SQL issuance processing unit 24 issues the test SQL together with a command for measuring an SQL execution time to the migration destination environment test database 13 under the control of the SQL sending control unit 22. In addition, the first SQL issuance processing unit 23 and the second SQL issuance processing unit 24 preferably similarly send a command for measuring a session execution time.

In step S4, the first response acquisition processing unit 25 acquires a response from the current environment test database 12, and the second response acquisition processing unit 26 acquires a response from the migration destination environment test database 13, and the acquired responses are supplied to the response comparison processing unit 27.

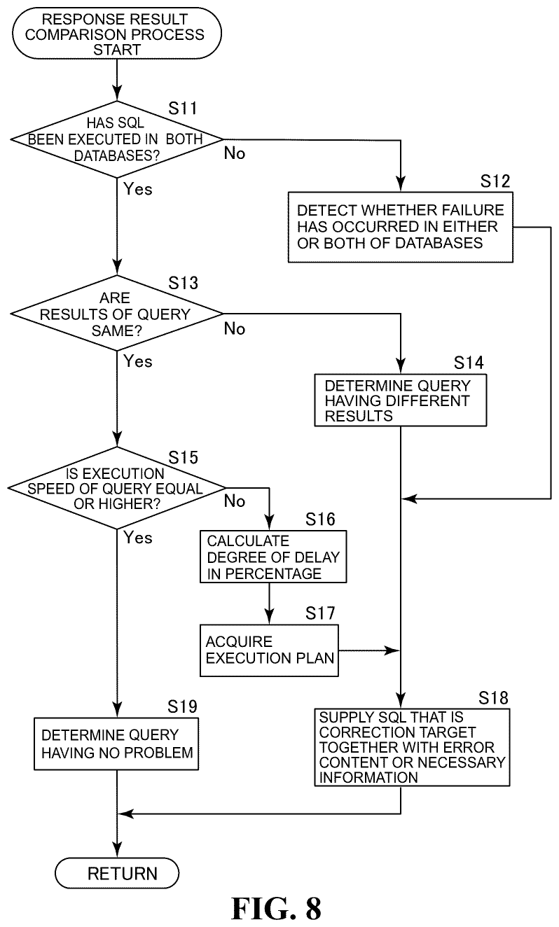

In step S5, a response result comparison process that will be described later with reference to a flowchart of FIG. 8 is executed.

In step S6, the display control processing unit 28 notifies a user of the comparison result of the SQL responses supplied from the current environment test database 12 and the migration destination environment test database 13 by controlling the display of a result of the database migration test as described with reference to FIG. 5 or FIG. 6, for example. The user refers to various types of information of which display is controlled by the display control processing unit 28, for example, the information described with reference to FIG. 5 or FIG. 6 or the execution plan operation of the SQL, and performs an operation input for correcting and converting the SQL for which it is determined that there is a problem, that is, the SQL for which a response has not been acquired from at least one of the current environment test database 12 and the migration destination environment test database 13, the SQL for which the response results of the current environment test database 12 and the migration destination environment test database 13 are not the same, and the SQL for which the execution speed of the SQL in the migration destination environment test database 13 is lower than the execution speed of the SQL in the current environment test database 12. The SQL conversion processing unit 30 executes a conversion process for testing again the SQL executed in the migration destination environment test database 13 on the basis of the user's operation input supplied from the input acquisition unit, and supplies a conversion result to the SQL sending control unit 22.

In step S7, the SQL sending control unit 22 determines whether or not the test of the current SQL has been ended. In a case where it is determined in step S7 that the test of the current SQL has not been ended, the processing returns to step S1, and the subsequent processing is repeated.

In a case where it is determined in step S7 that the test of the current SQL has been ended, in step S8, the SQL sending control unit 22 determines whether or not a correction result has been acquired from the SQL conversion processing unit 30. In step S8, in a case where it is determined that the correction result has been acquired from the SQL conversion processing unit 30, the processing returns to step S2, and the SQL sending control unit 22 controls the issuance, from the second SQL issuance processing unit 24, of a session including the test SQL after conversion supplied from the SQL conversion processing unit 30, and controls the issuance, from the first SQL issuance processing unit 23, of a session including the test SQL before conversion corresponding to the test SQL after conversion issued by the second SQL issuance processing unit 24, and the subsequent processing is repeated.

In a case where it is determined in step S8 that the correction result has not been acquired from the SQL conversion processing unit 30, in step S9, the operation input acquisition unit 29 determines whether or not an instruction to end the test has been given. In a case where it is determined in step S9 that an instruction to end the test has not been given, the processing returns to step S8, and the subsequent processing is repeated. In a case where it is determined in step S9 that an instruction to end the test has been given, the processing is ended.

Note that, in this flowchart, it is described that sending of the test SQL and comparison between the responses are sequentially performed, and then sending of the next test SQL is performed. However, as described with reference to FIG. 3, in the database, since a plurality of users can access the database and sequentially perform processing, that is, a plurality of sessions can be executed in parallel, sending of the test SQL can be sequentially performed without waiting for completion of a comparison process for the responses, and sending of the test SQL and the comparison process for the responses can be performed in parallel.

Next, a response result comparison process executed in step S5 in FIG. 7 will be described with reference to the flowchart of FIG. 8.

In step S11, on the basis of the information supplied from the first response acquisition processing unit 25 and the second response acquisition processing unit 26, the normal response presence/absence determination unit 41 determines whether a response to the test SQL has been acquired from the current environment test database 12 and the migration destination environment test database 13, that is, whether the test SQL has been successfully executed in both databases.

In a case where it is determined in step S11 that the test SQL cannot be executed in either of the databases, in step S12, the normal response presence/absence determination unit 41 detects in which database a failure has occurred or that a failure has occurred in both databases, and the processing proceeds to step S18.

In a case where it is determined in step S11 that the test SQL can be executed in both databases, in step S13, the normal response presence/absence determination unit 41 supplies the responses to the response result comparison unit 42. The response result comparison unit 42 compares the response results of the current environment test database 12 and the migration destination environment test database 13 supplied from the normal response presence/absence determination unit 41, and determines whether query results are the same.

In a case where it is determined in step S13 that the query results are not the same, in step S14, the response result comparison unit 42 determines that the response results obtained by the test SQL are different queries, and the processing proceeds to step S18.

In a case where it is determined in step S13 that the query results are the same, in step S15, the response result comparison unit 42 supplies information indicating that the response results are the same to the response time comparison unit 43 together with information regarding the execution time. The response time comparison unit 43 compares the execution times of the SQLs with the same response result, supplied from the response result comparison unit 42, and determines whether or not a query execution speed is equal or higher. In a case where it is determined in step S15 that the query execution speed is not equal or higher, the processing proceeds to step S19.

In a case where it is determined in step S15 that the query execution speed is not equal or higher, in step S16, the response time comparison unit 43 notifies the execution plan acquisition control unit 44 of the result, and calculates by what percentage the SQL execution speed in the migration destination environment test database 13 is slower than the SQL execution speed in the current environment test database 12.

In step S17, the execution plan acquisition control unit 44 instructs the first SQL issuance processing unit 23 and the second SQL issuance processing unit 24 to send a command for acquiring an execution plan of a corresponding SQL, and the execution plan acquisition control unit 44 receives supply of execution plans from the first response acquisition processing unit 25 and the second response acquisition processing unit 26.

After the process in step S12, step S14, or step S17 is ended, in step S18, the normal response presence/absence determination unit 41, the response result comparison unit 42, or the response time comparison unit 43 supplies an SQL that is a correction target together with error content or necessary information to the display control processing unit 28 and the SQL conversion processing unit 30, and the processing proceeds to step S6 in FIG. 7.

In a case where it is determined in step S15 that the query execution speed is equal or higher, in step S19, the response time comparison unit 43 determines that the query has no problem and supplies information indicating the result to the display control processing unit 28 and the SQL conversion processing unit 30, and the processing proceeds to step S6 in FIG. 7.

In the processing described with reference to FIG. 7, it has been described that the comparison test using the corrected SQL is performed after the comparison test of the current SQL is ended. However, as described with reference to FIG. 3, in the database, a plurality of users can access the database and sequentially perform processing, that is, a plurality of sessions can be executed in parallel. Therefore, in sending the test SQL, the current SQL and the corrected SQL may be mixed.

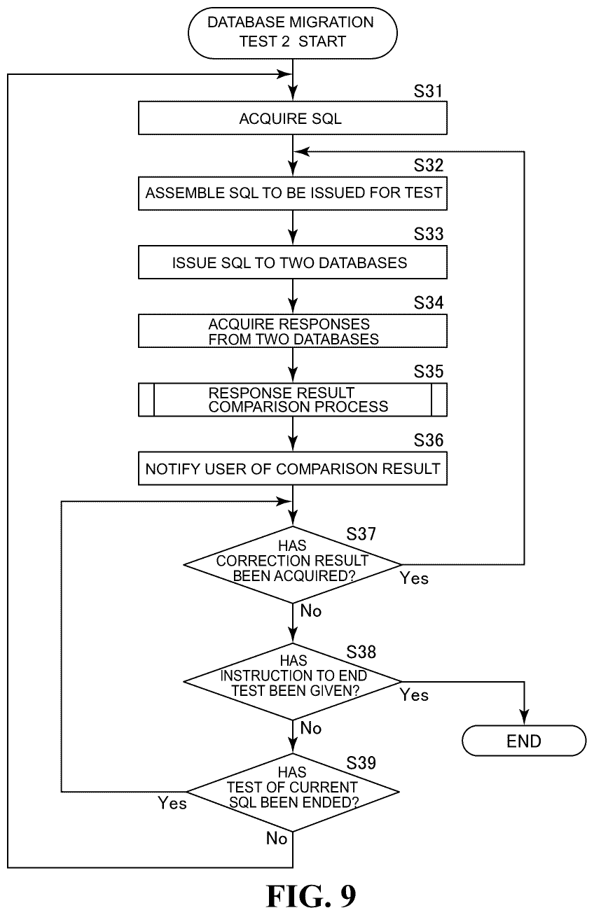

Next, a database migration test 2, which is an example of the database migration test executed by the database migration test device 11, will be described with reference to the flowchart of FIG. 9.

In steps S31 to S36, processes similar to those in steps SI to S6 described with reference to FIG. 7 are executed. That is, an SQL that is a source of a test SQL is acquired together with session information and a bind variable, and an SQL to be issued for a test is assembled. The test SQL is issued to the current environment test database 12 and the migration destination environment test database 13 together with a command for measuring an SQL execution time, and responses from the current environment test database 12 and the migration destination environment test database 13 are acquired. The response result comparison process described with reference to the flowchart of FIG. 8 is executed, and a user is notified of a comparison result of SQL responses as described with reference to FIG. 5 or FIG. 6, for example.

In step S37, the SQL sending control unit 22 determines whether or not a correction result is acquired from the SQL conversion processing unit 30. In step S37, in a case where it is determined that the correction result has been acquired from the SQL conversion processing unit 30, the processing returns to step S32, and the SQL sending control unit 22 controls the issuance, from the second SQL issuance processing unit 24, of a session including the test SQL after conversion supplied from the SQL conversion processing unit 30, and controls the issuance, from the first SQL issuance processing unit 23, of a session including the test SQL before conversion corresponding to the test SQL after conversion issued by the second SQL issuance processing unit 24, and the subsequent processing is repeated.

In a case where it is determined in step S37 that the correction result has not been acquired from the SQL conversion processing unit 30, in step S38, the operation input acquisition unit 29 determines whether or not an instruction to end the test has been given.

In a case where it is determined in step S38 that an instruction to end the test has not been given, in step S39, the SQL sending control unit 22 determines whether or not the test of the current SQL has been ended. In a case where it is determined in step S39 that the test of the current SQL has not been ended, the processing returns to step S31, and the subsequent processing is repeated.

In a case where it is determined in step S39 that the test of the current SQL has been ended, the processing returns to step S37, and the subsequent processing is repeated.

In a case where it is determined in step S38 that an instruction to end the test has been given, the processing is ended.

Note that, also in this flowchart, it has been described that sending of the test SQLs respectively corresponding to the current SQL and the corrected SQL, and comparison between the responses are sequentially performed, and then sending of the next test SQL is performed. However, as described with reference to FIG. 3, in the database, since a plurality of sessions can be executed in parallel, the test SQLs respectively corresponding to the current SQL and the corrected SQL can be sequentially sent without waiting for the end of the response comparison process. That is, the sending of the test SQL based on the current SQL, the sending of the test SQL based on the corrected SQL, and the comparison process of the respective responses can be processed in parallel.

### Summary of Effects

As described above, in the database migration test system 1 including the current environment test database 12 in the same environment as a current database, the migration destination environment test database 13 in the same environment as a database that is a migration destination, and the database migration test device 11, there are provided:
the first SQL issuance processing unit 23 that issues a test SQL to the current environment test database 12 together with a command for measuring an SQL execution time;
the second SQL issuance processing unit 24 that issues a test SQL to the migration destination environment test database 13 together with a command for measuring an SQL execution time;
the SQL sending control unit 22 that controls issuance of an SQL from the first SQL issuance processing unit 23 and the second SQL issuance processing unit 24;
the first response acquisition processing unit 25 that acquires a first response from the current environment test database 12;
a second response acquisition processing unit 26 that acquires a second response from the migration destination environment test database 13;
the normal response presence/absence determination unit 41 that determines whether the first response acquisition processing unit 25 and the second response acquisition processing unit 26 have acquired a normal first response and a normal second response;
a response result comparison unit 42 that compares the first response and the second response and determines whether the first response and the second response are the same in a case where the normal response presence/absence determination unit 41 determines that the normal first response and the normal second response are acquired; and
the response time comparison unit 43 that compares the respective execution times in a case where the response result comparison unit 42 determines that the first response and the second response are the same.

Therefore, in the database migration test, it is possible to check whether the migration destination database system operates correctly.

There is further provided the SQL acquisition processing unit 21 that acquires an SQL actually executed on the current database, and
the first SQL issuance processing unit 23 and the second SQL issuance processing unit 24 issue, as a test SQL, the SQL acquired by the SQL acquisition processing unit 21 and actually executed on the current database.

Therefore, in the database migration test, it is possible to check whether an SQL currently used operates correctly also in the environment of the migration destination database system.

The SQL acquisition processing unit 21 further acquires session information of an SQL actually executed on the current database, and
the first SQL issuance processing unit 23 and the second SQL issuance processing unit 24 issue the test SQL for each session on the basis of the session information.

Therefore, for example, it is possible to check an information acquisition result obtained by receiving a previous execution result, such as extracting necessary information after updating predetermined data that is, an operation as a cluster of a series of SQLs.

The first SQL issuance processing unit 23 and the second SQL issuance processing unit 24 issue the test SQL for each session.

Therefore, for example, it is possible to check an information acquisition result obtained by receiving a previous execution result, such as extracting necessary information after updating predetermined data, that is, an operation as a cluster of a series of SQLs.

There is further provided the execution plan acquisition control unit 44 that controls acquisition of an execution plan of a corresponding SQL in a case where the response time comparison unit 43 determines that an execution speed in the second response lower than an execution speed in the first response.

Therefore, it is possible to understand how the table is to be accessed by analyzing the execution plan in order to improve the performance in a case where the execution speed of the SQL is reduced.

In addition, the SQL sending control unit 22 performs control such that SQLs are simultaneously or substantially simultaneously issued from the first SQL issuance processing unit 23 and the second SQL issuance processing unit 24.

Therefore, the response from the current environment test database 12 supplied from the first response acquisition processing unit 25 and the response from the migration destination environment test database 13 supplied from the second response acquisition processing unit 26 can be acquired without much time difference. As a result, the comparison process can be performed at a high speed. In addition, in particular, details of a response result or a comparison result regarding an SQL that has operated without a problem are not used for subsequent processing, and thus unnecessary data can be sequentially erased depending on the capacity of a recording unit (not illustrated) included in the database migration test device 11.

There is further provided the SQL conversion processing unit 30 that performs an SQL conversion process, and
the SQL sending control unit 22 controls issuance, from the second SQL issuance processing unit 24, of a session including an SQL after conversion generated through conversion performed by the SQL conversion processing unit 30, and controls issuance, from the first SQL issuance processing unit 23, of a session including an SQL before conversion corresponding to the SQL after conversion issued by the second SQL issuance processing unit 24.

Therefore, it is possible to perform a conversion process on an SQL determined to have a problem, test the SQL again, and check an operation.

The above-described technology can be applied to, for example, a personal computer as hardware.

The above-described series of processes can be executed by hardware or software. In a case where the series of processes is executed by software, a program constituting the software is installed from a program recording medium to a computer incorporated in dedicated hardware, or a general-purpose personal computer or the like capable of executing various functions by installing various programs, for example.

Note that the program executed by the computer may be a program in which processes are performed in time series in the order described in the present specification, or may be a program in which processes are performed in parallel or at necessary timings such as in a case where a call is made. In addition, the program for executing the above-described series of processes may be one application program, or the above-described series of processes may be executed by executing a plurality of application programs.

In addition, embodiments of the present invention are not limited to the above-described embodiments, and can be variously modified without departing from the scope of the present invention.

### REFERENCE SIGNS LIST

1 Database migration test system
11 Database migration test device
12 Current environment test database
13 Migration destination environment test database
21 SQL acquisition processing unit
22 SQL sending control unit
23 First SQL issuance processing unit
24 Second SQL issuance processing unit
25 First response acquisition processing unit
26 Second response acquisition processing unit
27 Response comparison processing unit
28 Display control processing unit
29 Operation input acquisition unit
30 SQL conversion processing unit
41 Normal response presence/absence determination unit
42 Response result comparison unit
43 Response time comparison unit
44 Execution plan acquisition control unit

1. An information processing system including a first database in the same environment as a current database, a second database in the same environment as a migration destination database, and an information processing device,
the information processing device including:
first SQL issuance processing means for issuing a test SQL to the first database together with a command for measuring an execution time of the test SQL;
second SQL issuance processing means for issuing the test SQL to the second database together with a command for measuring an execution time of the test SQL;
SQL sending control means for controlling issuance of the SQL from the first SQL issuance processing means and the second SQL issuance processing means;
first response acquisition processing means for acquiring a first response from the first database;
second response acquisition processing means for acquiring a second response from the second database;
normal response presence/absence determination means for determining whether the first response acquisition processing means and the second response acquisition processing means have acquired the normal first response and the normal second response;
response result comparison means for comparing the first response and the second response to determine whether the first response and the second response are the same in a case where the normal response presence/absence determination means determines that the normal first response and the normal second response have been acquired; and
response time comparison means for comparing respective execution times in a case where the response result comparison means determines that the first response and the second response are the same.

2. An information processing device comprising:
first SQL issuance processing means for issuing a test SQL to a first database in the same environment as a current database together with a command for measuring an SQL execution time;
second SQL issuance processing means for issuing the test SQL together with a command for measuring an SQL execution time to a second database in the same environment as a database that is a migration destination;
the SQL sending control means for controlling issuance of the SQL from the first SQL issuance processing means and the second SQL issuance processing means;
first response acquisition processing means for acquiring a first response from the first database;
second response acquisition processing means for acquiring a second response from the second database;
normal response presence/absence determination means for determining whether the first response acquisition processing means and the second response acquisition processing means have acquired the normal first response and the normal second response;
response result comparison means for comparing the first response and the second response to determine whether the first response and the second response are the same in a case where the normal response presence/absence determination means determines that the normal first response and the normal second response have been acquired; and
response time comparison means for comparing respective execution times in a case where the response result comparison means determines that the first response and the second response are the same.

3. The information processing device according to claim 2, further comprising:
SQL acquisition processing means for acquiring an SQL actually executed on the current database, wherein
the first SQL issuance processing means and the second SQL issuance processing means issue, as the test SQL, an SQL acquired by the SQL acquisition processing means and actually executed on the current database.

4. The information processing device according to claim 3, wherein
the SQL acquisition processing means further acquires session information of the SQL actually executed on the current database, and
the first SQL issuance processing means and the second SQL issuance processing means issue the test SQL for each session on the basis of the session information.

5. The information processing device according to claim 2, wherein
the first SQL issuance processing means and the second SQL issuance processing means issue the test SQL for each session.

6. The information processing device according to claim 2, further comprising:
execution plan acquisition control means for controlling acquisition of an execution plan of a corresponding SQL in a case where the response time comparison means determines that an execution speed in the second response is lower than an execution speed in the first response.

7. The information processing device according to claim 2, wherein
the SQL sending control means performs control such that the first SQL issuance processing means and the second SQL issuance processing means issue the SQL simultaneously or substantially simultaneously.

8. The information processing device according to claim 2, further comprising:
SQL conversion processing means for performing a conversion process on the SQL, wherein
the SQL sending control means controls issuance, from the second SQL issuance processing means, of a session including an SQL after conversion generated through conversion performed by the SQL conversion processing means, and controls issuance, from the first SQL issuance processing means, of a session including an SQL before conversion corresponding to the SQL after conversion issued by the second SQL issuance processing means.

9. An information processing method in an information processing device that executes a database migration test, the method comprising:
a first SQL issuance processing step of issuing a test SQL to a first database in the same environment as a current database together with a command for measuring an SQL execution time;
a second SQL issuance processing step of issuing the test SQL together with a command for measuring an SQL execution time to a second database in the same environment as a database that is a migration destination;
a first response acquisition step of acquiring a first response from the first database;
a second response acquisition step of acquiring a second response from the second database;
a normal response presence/absence determination step of determining whether the normal first response and the normal second response have been acquired in the first response acquisition step and the second response acquisition step;
a response result comparison step of comparing the first response and the second response and determining whether the first response and the second response are the same in a case where it is determined that the normal first response and the normal second response have been acquired through the process in the normal response presence/absence determination step; and
a response time comparison step of comparing respective execution times in a case where it is determined that the first response and the second response are the same through the process in the response result comparison step.

10. A program for causing a computer configuring a database migration test device to execute:
a first SQL issuance processing step of issuing a test SQL to a first database in the same environment as a current database together with a command for measuring an SQL execution time;
a second SQL issuance processing step of issuing the test SQL together with a command for measuring an SQL execution time to a second database in the same environment as a database that is a migration destination;
a first response acquisition step of acquiring a first response from the first database;
a second response acquisition step of acquiring a second response from the second database;
a normal response presence/absence determination step of determining whether the normal first response and the normal second response have been acquired in the first response acquisition step and the second response acquisition step;
a response result comparison step of comparing the first response and the second response and determining whether the first response and the second response are the same in a case where it is determined that the normal first response and the normal second response have been acquired through the process in the normal response presence/absence determination step; and
a response time comparison step of comparing respective execution times in a case where it is determined that the first response and the second response are the same through the process in the response result comparison step.
